(19) United States
(12) Patent Application Publication
(10) Pub. No.: US 2008/0227399 A1
(43) Pub. Date: Sep. 18, 2008

(54) Mobile device system and mobile device

(76) Inventors: Hideki Nagata, Hachioji-shi (JP); Hiroyuki Minakata, Hachioji-shi (JP); Takayuki Ide, Fussa-shi (JP); Atsushi Kohashi, Akiruno-shi (JP); Minoru Omaki, Kunitachi-shi (JP)

Correspondence Address: KENYON & KENYON LLP, ONE BROADWAY, NEW YORK, NY, 10004, US

(21) Appl. No.: 11/903,246

(22) Filed: Sep. 20, 2007

(30) Foreign Application Priority Data
Sep. 28, 2006 (JP) 2006-264752

(51) Int. Cl. H04B 7/24

(52) U.S. Cl. 455/66.1

(57) ABSTRACT

Situations such as mobile devices being left in the activated mode are avoided by efficiently reporting the statuses of a plurality of mobile devices.

Provided is a mobile device system including a plurality of mobile devices. Each mobile device includes a status-detecting unit for detecting the status of that device, a communication unit for communicating with other mobile devices, a display unit, and a control unit. The control unit of each of the mobile devices sends the status detected by the status-detecting unit to the other mobile devices by using the communication unit, and when statuses are received by the communication unit from the other mobile devices, those statuses are displayed on the display unit.

### BACKGROUND OF THE INVENTION

1. Field of the Invention

The present invention relates to a mobile device system and a mobile device which can report the statuses of a plurality of mobile devices using a single mobile device.

This application is based on Japanese Patent Application No. 2006-264752, the content of which is incorporated herein by reference.

2. Description of Related Art

Recently, due to the diversification of information, when people go out, in many cases they carry multiple mobile devices having various functions, such as mobile phones, laptop computers, information communication terminals, computers, and music players (see Japanese Unexamined Patent Application, Publication No. 2002-9879).

For example, Japanese Unexamined Patent Application, Publication No. 2002-9879 discloses use of multiple mobile devices in combination by sending image data captured with a personal computer to a mobile phone via a local network and then further sending it onto an external network using the mobile phone.

### BRIEF SUMMARY OF THE INVENTION

A first aspect of the present invention is a mobile device system including a plurality of mobile devices; wherein each mobile device includes a status-detecting unit for detecting a status of that device, a communication unit for communicating with other mobile devices, a reporting unit, and a control unit; wherein the control unit of each of the mobile devices sends the status detected by the status-detecting unit to the other mobile devices by using the communication unit and, when statuses are received by the communication unit from the other mobile devices, controls the reporting unit so as to report the statuses.

A second aspect of the present invention is mobile device including a status-detecting unit for detecting a status of that device; a communication unit for communicating with other mobile devices; a reporting unit; and a control unit, wherein the control unit sends the status detected by the status-detecting unit to the other mobile devices by using the communication unit and, when statuses are received by the communication unit from the other mobile devices, controls the reporting unit so as to report the statuses.

### BRIEF DESCRIPTION OF THE SEVERAL VIEWS OF THE DRAWINGS

FIG. 1 is a diagram showing the configuration of a mobile device system.

FIG. 2 is a diagram showing common components provided in each mobile device in the mobile device system.

FIG. 3 is a flowchart showing a procedure of a process executed by a control unit.

FIG. 4 is a diagram showing an example of the display screen of a mobile phone.

### DETAILED DESCRIPTION OF THE INVENTION

A mobile device system of the present invention includes a plurality of mobile devices; wherein each mobile device includes a status-detecting unit for detecting a status of that device, a communication unit for communicating with other mobile devices, a reporting unit, and a control unit; wherein the control unit of each of the mobile devices sends the status detected by the status-detecting unit to the other mobile devices by using the communication unit and, when statuses are received by the communication unit from the other mobile devices, controls the reporting unit so as to report the statuses.

According to this configuration, the status of each mobile device is detected by the status-detecting unit, and this status information is sent to the other mobile devices by the communication unit. In each mobile device, when the status information of the other mobile devices is received by the communication unit, this status information is reported by the reporting unit; therefore, the user can recognize the statuses of the other mobile devices. For example, as the status information, by reporting whether or not the device is in the activated mode, the user can quickly notice that a mobile device that is not being used has been left in the activated mode.

In the mobile device system described above, the control unit of the mobile device which is detected as being in the activated mode by the status-detecting unit may send a send-status request to the other mobile devices by operating the communication unit, and when status information for the send-status request is received from the other mobile devices, the status information of the other mobile devices may be reported by the reporting unit.

According to this configuration, when the mobile device is operated by the user, because the status information of the other mobile devices is reported by the reporting unit of that mobile device, the user can ascertain the statuses of the other mobile device on the mobile device which he or she has activated for use. Thus, it is possible to recognize the statuses of the other mobile devices efficiently, without going to the trouble of activating the other mobile devices.

In the mobile device system described above, when the reporting unit is the display unit, the display unit may display the status of that device and the statuses of the other mobile devices in a distinguishable manner.

According to this configuration, because the status of each mobile device is displayed on the display unit of each mobile device in a distinguishable manner, the user can readily ascertain the status of each mobile device.

In the mobile device system described above, the display unit may display the statuses of the plurality of mobile devices using different icons.

According to this configuration, because the status of each mobile device is displayed on the display unit of each mobile device with different icons, the user can readily ascertain the status of each mobile device.

In the mobile device system described above, the status of the mobile device may be remaining battery level, and the display unit may change and display the shapes of the icons according to the remaining battery level.

According to this configuration, because the remaining battery level of a certain mobile device and the remaining battery levels of the other mobile devices are displayed on the display unit of each mobile device using icons according to those levels, the user can readily ascertain the remaining battery level of each mobile device by checking the display unit.

A mobile device of the present invention includes a status-detecting unit for detecting a status of that device; a communication unit for communicating with other mobile devices; a reporting unit; and a control unit, wherein the control unit sends the status detected by the status-detecting unit to the other mobile devices by using the communication unit and, when statuses are received by the communication unit from the other mobile devices, controls the reporting unit so as to report the statuses.

According to this configuration, when the status of a certain device which is detected by the status-detecting unit is sent to the other mobile devices by the communication unit and the statuses of the other mobile devices are received by the communication unit, those statuses are reported by the reporting unit. Therefore, the user can recognize the statuses of the other mobile devices by using one mobile device.

The various aspects described above can be used in combination within the permissible scope of the invention.

### ADVANTAGES OF THE INVENTION

The mobile device system and the mobile device of the present invention afford an advantage in that, because the statuses of a plurality of mobile devices are efficiently reported, it is possible to avoid a situation such as a mobile device being left in the activated mode.

An embodiment of a mobile device system will be described below with reference to the drawings.

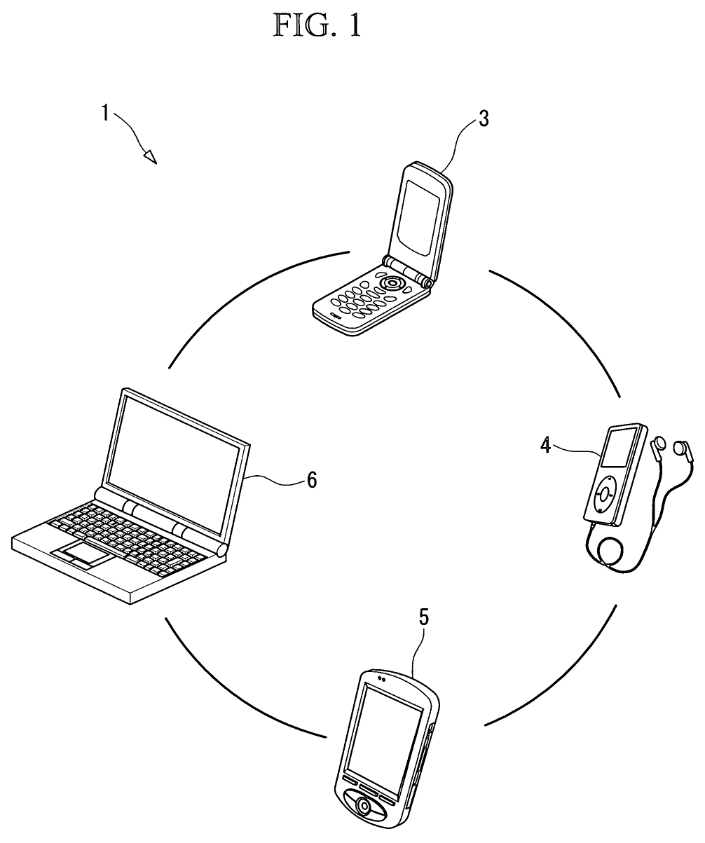

FIG. 1 illustrates an example configuration of a mobile device system 1. As shown in the drawing, the mobile device system 1 includes a plurality of mobile devices, more specifically, a mobile phone 3, a portable music player 4, a PDA (personal digital assistant) 5, and a laptop computer (hereinafter referred to as ‘computer’) 6. These mobile devices are only examples, and in general, any type of portable electronic device may be used in any combination.

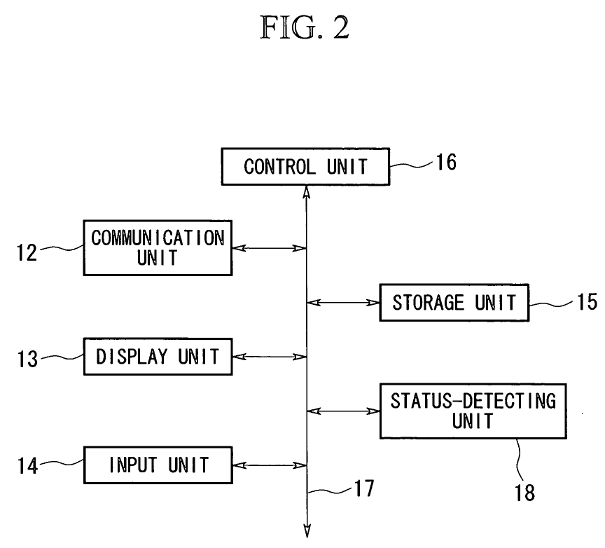

Each of the above-described mobile devices includes the following common components. Specifically, as illustrated in FIG. 2, each mobile device includes a communication unit (communication device) 12, a display unit (reporting device) 13, an input unit 14, a storage unit 15, a control unit (control device) 16, and a status-detecting unit (status-detecting device) 18. These units are mutually connected via a bus 17 and are configured to be capable of sending and receiving information between each other.

The components described above may be provided separately from components that are generally included in each mobile device, or they may be used in conjunction with the components generally included in each mobile device. For example, the mobile phone 3 generally includes a communication unit, a display unit, and an input unit; therefore, of these components, the components that are duplicated are preferably used in conjunction therewith. This also applies to the other mobile devices.

The communication unit 12 is capable of communicating with other mobile devices wirelessly. For example, the communication unit 12 of the mobile phone 3 is capable of communicating with the portable music player 4, the PDA 5, and the computer 6.

The display unit 13 is, for example, a liquid crystal display. The input unit 14 is, for example, a keyboard or buttons and functions as a man-machine interface.

The storage unit 15 holds information about the other mobile devices. Specifically, it stores identification information about each of the other mobile devices, and various types of information is linked to each item of identification information, such as a device name, information for enabling two-way communication, icon information to be displayed on the display unit 13, and so forth. The information for enabling two-way communication is, for example, an IP address of the other party.

Regarding the icon information displayed on the display unit 13, a plurality of icons are stored corresponding to the statuses of the device. For example, an icon corresponding to the activated mode, an icon corresponding to the standby mode, a plurality of icons corresponding to the remaining battery levels, and so on are registered in each mobile device. Here, the icon corresponding to the activated mode and the icon corresponding to the standby mode are displayed with different appearances so that the user can easily distinguish whether the device is in the activated mode or the standby mode. In this embodiment, the icon corresponding to the activated mode is drawn with solid lines, and the icon corresponding to the standby mode is drawn with dotted lines. These appearances are merely examples, however, and the icon corresponding to the activated mode may have an appearance like the icon corresponding to the standby mode, with shading or the like further applied thereto.

The control unit 16 performs overall control of each of the units described above.

The status-detecting unit 18 periodically detects the status of that mobile device, for example, the remaining battery level, whether or not it is in the activated mode, and so forth, and outputs the detection result to the control unit 16. Accordingly, information about whether or not the device is in the activated mode, as well as the remaining battery level, is periodically input to the control unit 16.

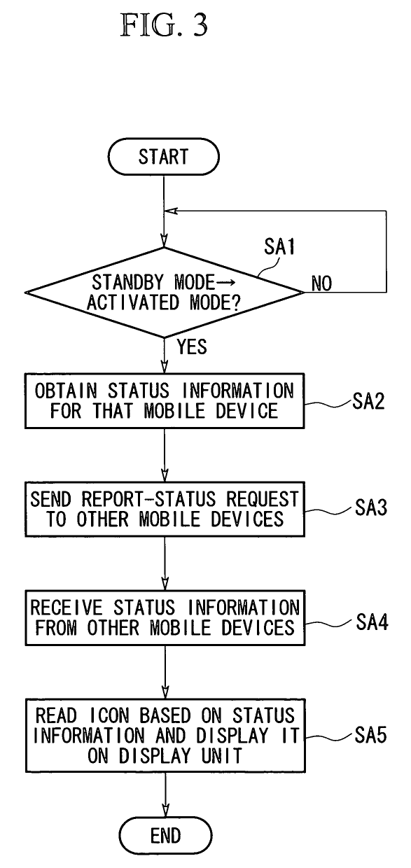

In each of the mobile devices having such a common configuration, a process as shown in FIG. 3 is executed by the control unit 16. Although the process shown below is executed in the control unit 16 of each mobile device, for simplification, the control unit 16 of the mobile phone 3 will be described here as a representative example.

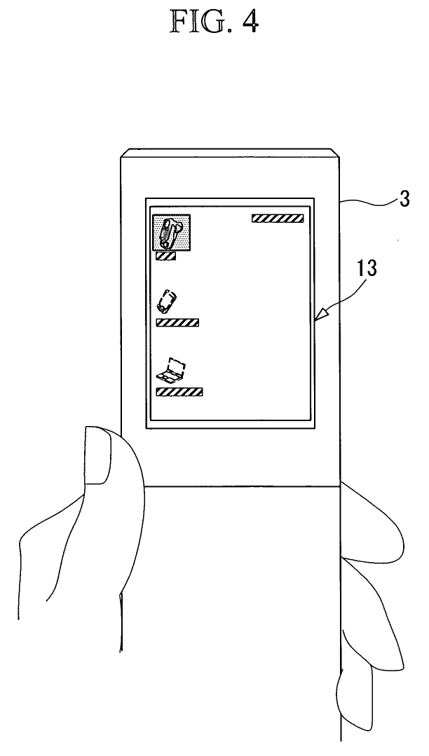

First, when it is detected by the status-detecting unit 18 that the mobile phone 3 is in the activated mode (“YES” at step SA1 in FIG. 4) as a result of the mobile phone 3 being operated by the user, the control unit 16 of the mobile phone 3 obtains information about the remaining battery level of that device from the status-detecting unit 18 (step SA2) and operates the communication unit 12 to send a report-status request to the other mobile devices (step SA3). Thus, the report-status request is received by the communication units 12 of the portable music player 4, the PDA 5, and the computer 6.

The control unit 16 of each mobile device which receives this report-status request links the status information detected by the status-detecting unit 18, specifically, information about whether the device is in the activated mode or the standby mode and the remaining battery level, to its own identification information, and sends it back to the source of that request, in other words the mobile phone 3. Accordingly, the status information of each mobile device is received by the communication unit 12 of the mobile phone 3 (step SA4).

Next, the control unit 16 of the mobile phone 3 obtains the corresponding icon from the storage unit 15 on the basis of the status information received from the other mobile devices and displays the obtained icon on the display unit 13 (step SA5).

For example, when the status information “activated mode” and “remaining battery level: medium” are received from the portable music player 4 and the status information “standby mode” and “remaining battery level: high” are received from the PDA 5 and the computer 6, the control unit 16 of the mobile phone 3 obtains the icons corresponding to this status information from the storage unit 15 and displays them on the display unit 13. Thus, a screen like that shown in FIG. 5 is displayed on the display unit 13 of the mobile phone 3. In this case, as shown in FIG. 5, the icon for the portable music player 4 in the activated mode and the icons for the PDA 5 and the computer 6 in the standby mode are displayed with different appearances, and therefore, it is possible to easily distinguish the mobile device which is in the activated mode. Accordingly, the user can quickly notice the existence of other mobile devices that have been left in the activated mode and can thus reduce wasteful power consumption by taking immediate action.

As described above, with such a mobile device system 1, when one mobile device is activated by the user, the statuses of the other mobile devices are displayed on the display unit 13 of that mobile device; therefore, by looking at the display unit of the activated mobile device, the user can also check the statuses of the other mobile devices. Thus, when there is a mobile device in the activated mode, that fact can quickly be noticed. As a result, it is possible to reduce wasteful power consumption of the mobile devices, and it is possible to avoid problems such as the inability to use a device due to insufficient battery power when the user wishes to use it.

In addition, because the display appearance of the icon changes according to the activated mode, the user can easily recognize the mobile devices in the activated mode.

The size of the display unit 13 in each mobile device is different. Therefore, the appearance or content of the icons displayed may change according to the size of the display unit 13. For example, the display units 13 of the mobile phone 3 and the portable music player 4 are smaller than the display units 13 of the PDA 5 and the computer 6. Therefore, only information about the mobile devices that is necessary for drawing the user's attention may be displayed on the mobile phone 3 and the portable music player 4.

For example, for a mobile device in the standby mode or whose remaining battery level is high, it is not particularly necessary to draw the user's attention. In contrast, for a mobile device in the activated mode or a mobile device whose remaining battery level is low, it is necessary to quickly report that fact to the user so that he or she can quickly take action. Therefore, only the mobile device in the activated mode or the mobile device whose remaining battery level is low may be displayed on the mobile device with the small display unit 13, and the statuses of all of the other mobile devices may be displayed on the PDA 5 and the computer 6, whose display units 13 are large, in addition to displaying more details about those statuses. Accordingly, by changing the displayed information according to the size of the display unit 13, it is possible to report the statuses of the other mobile device effectively.

In this embodiment, the statuses of the other mobile devices are reported to the user by displaying them on the display unit 13. Instead of this, however, they may be reported using audio. In this case, an audio output unit for outputting sound, such as a speaker, is provided in addition to the components shown in FIG. 2.

In this embodiment, of the other mobile devices, when there is a mobile device in the activated mode or a mobile device whose remaining battery level is at or below a predetermined value that is registered in advance, an announcing unit for announcing that mobile device may also be provided. Thus, by announcing a mobile device in the activated mode or whose remaining battery level is low by using the announcing unit, in addition to the display described above, the user's attention can be drawn even more effectively. Thus, it is possible to avoid problems such as the battery running out because the device has been left in the activated mode, making it impossible to use when the user wishes to use it. A unit that announces using audio, such as a speaker, a unit that announces by illuminating, such as an LED, or a unit that announces by vibrations, such as a vibrator, can be employed as the announcing unit.

Although an embodiment of the mobile device system and the mobile device have been described above with reference to the drawings, the specific configuration is not limited to this embodiment. The present invention encompasses various modifications so long as they do not depart from the spirit of the invention.

What is claimed is:

1. A mobile device system comprising:
a plurality of mobile devices;
wherein each mobile device includes a status-detecting unit for detecting a status of that device, a communication unit for communicating with other mobile devices, a reporting unit, and a control unit;
wherein the control unit of each of the mobile devices sends the status detected by the status-detecting unit to the other mobile devices by using the communication unit and, when statuses are received by the communication unit from the other mobile devices, controls the reporting unit so as to report the statuses.

2. A mobile device system according to claim 1, wherein the control unit of the mobile device which is detected as being in an activated mode by the status-detecting unit sends a send-status request to the other mobile devices by operating the communication unit, and when status information for the send-status request is received from the other mobile devices, the status information of the other mobile devices is reported by the reporting unit.

3. A mobile device system according to claim 1 wherein, when the reporting unit is the display unit, the display unit displays the status of that device and the statuses of the other mobile devices in a distinguishable manner.

4. A mobile device system according to claim 3, wherein the display unit displays the statuses of the plurality of mobile devices using different icons.

5. The mobile device system according to claim 4, wherein the status of the mobile device is remaining battery level, and the display unit changes and displays the shapes of the icons according to the remaining battery level.

6. A mobile device comprising:
a status-detecting unit for detecting a status of that device;
a communication unit for communicating with other mobile devices;
a reporting unit; and
a control unit,
wherein the control unit sends the status detected by the status-detecting unit to the other mobile devices by using the communication unit and, when statuses are received by the communication unit from the other mobile devices, controls the reporting unit so as to report the statuses.
